(19) United States
(12) Patent Application Publication
(10) Pub. No.: US 2026/0104386 A1
(43) Pub. Date: Apr. 16, 2026

(54) MODULAR FLUIDIC SYSTEMS AND METHODS FOR CONSUMABLE-BASED PARALLEL CAPILLARY ELECTROPHORESIS

(71) Applicant: Agilent Technologies, Inc., Santa Clara, CA (US)

(72) Inventors: Paul Griesz, Santa Clara, CA (US); Michael Stebniski, Santa Clara, CA (US); Jorge Sánchez Timón, Santa Clara, CA (US)

(21) Appl. No.: 18/912,398

(22) Filed: Oct. 10, 2024

(51) Int. Cl. G01N 27/447

(52) U.S. Cl. CPC G01N 27/44756

(57) ABSTRACT

Systems and methods for modular fluidic systems and methods for parallel capillary electrophoresis are described herein. The system can include a housing, a manifold assembly, and a reservoir assembly. The manifold assembly can include a manifold connector. The reservoir assembly can include a reservoir and a reservoir connector. In a first configuration, the manifold assembly can couple with the reservoir assembly including the reservoir having a first volume. In a second configuration, the manifold assembly can couple with the reservoir assembly including the reservoir having a second volume different from the first volume.

### TECHNICAL FIELD

The present application relates generally to capillary electrophoresis.

### BACKGROUND

Capillary electrophoresis (CE) can be used to assess the size, purity, and composition of samples by separating analytes (e.g., ions) in a capillary. The analytes can migrate through the capillary using an applied electric field. The analytes can be separated based on their electrophoretic mobility.

### SUMMARY

Fluidic components, such as a reservoir, can be a fixed part of a capillary electrophoresis instrument. For a given CE instrument, the volume of the reservoir is a permanent (e.g., fixed) parameter. The solutions described herein can provide a modular fluidic system for consumable-based parallel capillary electrophoresis in which the reservoir is part of the consumable component and a fluidic manifold is part of the instrument. This can allow for modularity by changing the reservoir volume from a permanent parameter to an adjustable parameter. The systems and methods of the present disclosure allow for different combinations of capillaries, reservoir volume, and applications with the same CE instrument by exchanging the consumable component.

At least one aspect of the present disclosure is directed to a capillary electrophoresis (CE) system. The CE system can include a housing. The CE system can include a manifold assembly. The manifold assembly can fixedly couple with the housing. The manifold assembly can include a manifold connector. The manifold connector can include a first portion of a first passage. The manifold connector can include a first portion of a second passage. The CE system can include a reservoir assembly. The reservoir assembly can removably couple with the manifold assembly. The reservoir assembly can receive a plurality of capillaries. The reservoir assembly can include a reservoir disposed in the reservoir assembly. The reservoir assembly can include a reservoir connector. The reservoir connector can interface with the manifold connector. The reservoir connector can include a second portion of the first passage. The second portion of the first passage can be fluidically coupled with the first portion of the first passage. The reservoir connector can include a second portion of the second passage. The second portion of the second passage can be fluidically coupled with the first portion of the second passage. In a first configuration, the manifold assembly can couple with the reservoir assembly. The reservoir assembly can include the reservoir having a first volume. In a second configuration, the manifold assembly can couple with the reservoir assembly. The reservoir assembly can include the reservoir having a second volume different from the first volume.

Another aspect of the present disclosure is directed to a reservoir assembly. A reservoir can be disposed in the reservoir assembly. The reservoir assembly can removably couple with a manifold connector. The reservoir assembly can receive a plurality of capillaries. The reservoir assembly can include a reservoir connector. The reservoir connector can interface with the manifold connector. The reservoir assembly can include a second portion of a first passage disposed in the reservoir connector. The second portion of the first passage can be fluidically coupled with a first portion of the first passage. The first portion of the first passage can be disposed in the manifold connector. The reservoir assembly can include a second portion of a second passage. The second portion of the second passage can be disposed in the reservoir connector. The second portion of the second passage can be fluidically coupled with a first portion of the second passage disposed in the manifold connector. The reservoir can have a first volume or a second volume different from the first volume.

Another aspect of the present disclosure is directed to a method. The method can include providing a reservoir assembly. The reservoir assembly can include a reservoir disposed in the reservoir assembly. The reservoir assembly can removably couple with a manifold connector. The reservoir assembly can receive a plurality of capillaries. The reservoir assembly can include a reservoir connector. The reservoir connector can interface with the manifold connector. The reservoir assembly can include a second portion of a first passage disposed in the reservoir connector. The second portion of the first passage can be fluidically coupled with a first portion of the first passage disposed in the manifold connector. The reservoir assembly can include a second portion of a second passage disposed in the reservoir connector. The second portion of the second passage can be fluidically coupled with a first portion of the second passage disposed in the manifold connector. The reservoir can have a first volume or a second volume different from the first volume.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a schematic diagram of a capillary electrophoresis system in accordance with an embodiment.

FIG. 2 is a schematic diagram of a portion of the capillary electrophoresis system in accordance with an embodiment.

FIG. 3 is a schematic diagram of a portion of the capillary electrophoresis system in accordance with an embodiment.

FIG. 4 is a schematic diagram of a portion of the capillary electrophoresis system in accordance with an embodiment.

FIG. 5 is a schematic diagram of a cartridge in accordance with an embodiment.

FIG. 6 is a schematic diagram of a portion of the capillary electrophoresis system in accordance with an embodiment.

FIG. 7 is a schematic diagram of a portion of the capillary electrophoresis system in accordance with an embodiment.

FIG. 8A is a schematic diagram of a cross-section of a portion of a reservoir assembly in accordance with an embodiment.

FIG. 8B is a schematic diagram of a cross-section of a portion of the reservoir assembly in accordance with an embodiment.

FIG. 9A is a schematic diagram of a cross-section of a portion of the reservoir assembly and a portion of a manifold assembly in accordance with an embodiment.

FIG. 9B is a schematic diagram of a cross-section of a portion of the reservoir assembly and a portion of the manifold assembly in accordance with an embodiment.

FIG. 10 is a schematic diagram of a cross-section of a portion of the reservoir assembly and a portion of the manifold assembly in accordance with an embodiment.

FIG. 11 is a schematic diagram of a portion of the capillary electrophoresis system in accordance with an embodiment.

FIG. 12 is a schematic diagram of a portion of the capillary electrophoresis system in accordance with an embodiment.

FIG. 13 is a schematic flow diagram illustrating a method for providing and/or using a reservoir assembly in accordance with an embodiment.

Like reference numbers and designations in the various drawings indicate like elements.

### DETAILED DESCRIPTION

Following below are more detailed descriptions of various concepts related to, and implementations of modular fluidic systems and methods for parallel capillary electrophoresis. The various concepts introduced above and discussed in greater detail below may be implemented in any of a number of ways, as the described concepts are not limited to any particular manner of implementation. Examples of specific implementations and applications are provided primarily for illustrative purposes.

Fluidic components, such as a reservoir, can be a fixed part of a capillary electrophoresis instrument. For a given CE instrument, the volume of the reservoir is a permanent or fixed parameter. Different CE instruments may be needed to accommodate different reservoir volumes.

Embodiments of the present disclosure describe modular fluidic systems and methods for parallel capillary electrophoresis. The solutions described herein can provide a modular fluidic system for consumable-based parallel capillary electrophoresis in which the reservoir is part of the consumable component and a fluidic manifold that is part of the instrument. This can allow for modularity by changing the reservoir volume from a permanent parameter to an adjustable parameter. The systems and methods of the present disclosure allow for different combinations of capillaries, reservoir volume, and applications with the same CE instrument by exchanging the consumable component.

The disclosed solutions have a technical advantage of providing a base instrument that can work with different cartridge reservoir volumes. This can allow for a more flexible instrument that can be used just by exchanging the consumable (e.g., replaceable components, exchangeable components). The solutions can optimize consumable usage by limiting or eliminating non-optimal reservoir volumes. The solutions can reduce cross contamination when two different assays or sensitive assays are run on the same system (e.g., protein & RNA) by using a protein specific consumable and an RNA specific consumable in the same instrument. This can allow for a more reproducible separation and higher performance. The solutions can reduce swept volume and dead volume by reducing tubing and connectors. This can reduce contamination and allow for higher precision and separation performance due to a more controlled environment.

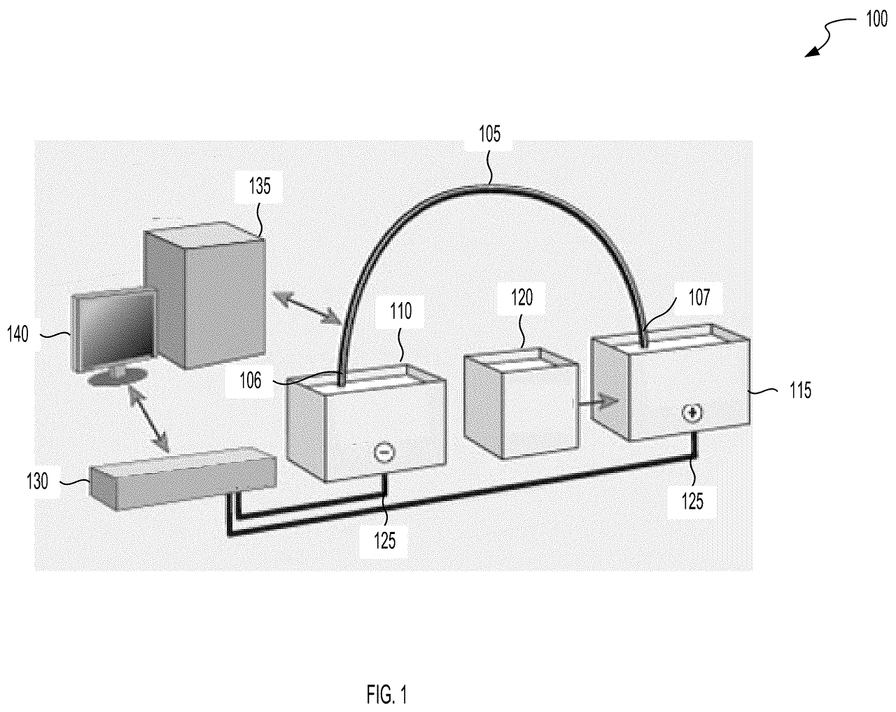

FIG. 1 is a schematic diagram of a capillary electrophoresis system 100 (e.g., CE system, CE device, consumable-based CE system). The CE system 100 can include a representative CE system. The CE system 100 can include a CE instrument. The CE instrument can include components (e.g., fluidic components) of the CE system 100 that are not consumables. The CE system 100 can include a fluidic system. For example, the CE system 100 can include a modular (e.g., modularized) fluidic system. The CE system 100 can be used for high-throughput electrophoresis applications. For example, the CE system 100 can be used for high-throughput parallel capillary electrophoresis applications.

The CE system 100 can include a plurality of capillaries 105 (e.g., capillary array, capillary bundle). For example, the plurality of capillaries 105 can include 12 capillaries. The plurality of capillaries 105 can include between 48 and 96 capillaries. Each capillary of the plurality of capillaries 105 can include a fused-silica capillary. For example, each capillary of the plurality of capillaries 105 can include a narrow-bore, fused-silica capillary.

The CE system 100 can include an outlet reservoir 110. The outlet reservoir 110 can be filled with a solution (e.g., buffer solution). The outlet reservoir 110 can be fluidically (e.g., fluidly) coupled with (e.g., connected to, attached to) the plurality of capillaries 105. For example, a first end 106 of each of the plurality of capillaries 105 can be fluidically coupled with the outlet reservoir 110. The plurality of capillaries 105 can be inserted into the outlet reservoir 110. For example, the plurality of capillaries 105 can be inserted into (e.g., disposed in) the solution disposed in the outlet reservoir 110. A plurality of tips (e.g., capillary tips) of the first end 106 of each of the plurality of capillaries 105 can be inserted into the solution disposed in the outlet reservoir 110.

The CE system 100 can include an inlet reservoir 115. The inlet reservoir 115 can be filled with a solution (e.g., buffer solution). The inlet reservoir 115 can be fluidically coupled with the plurality of capillaries 105. For example, a second end 107 of each of the plurality of capillaries 105 can be fluidically coupled with the inlet reservoir 115. The second end 107 of each of the plurality of capillaries 105 can be opposite the first end 106 of each of the plurality of capillaries 105. The plurality of capillaries 105 can be inserted into the inlet reservoir 115. For example, the plurality of capillaries 105 can be inserted into the solution disposed in the inlet reservoir 115. The plurality of capillary tips of the second end 107 of each of the plurality of capillaries 105 can be inserted into the solution disposed in the inlet reservoir 115. The inlet reservoir 115 can be moved towards the plurality of capillaries 105 such that the second end 107 of each of the plurality of capillaries 105 fluidically couples with the inlet reservoir 115.

The CE system 100 can include one or more sample trays 120. The sample tray 120 can include a plurality of wells. For example, the sample tray 120 can include a 96-well sample tray. Each sample can be disposed in each well of the sample tray. The sample can include, for example, proteins (e.g., antibodies, enzymes). The sample tray 120 can move to the location of the inlet reservoir 115. For example, the sample tray 120 can take the place of the inlet reservoir 115. The sample tray 120 can be fluidically coupled with the plurality of capillaries 105. For example, the second end 107 of each of the plurality of capillaries 105 can be fluidically coupled with the sample tray 120. The plurality of capillaries 105 can be inserted into the sample tray 120. For example, the plurality of capillaries 105 can be inserted into samples disposed in the sample tray 120. The plurality of capillary tips of the second end 107 of each of the plurality of capillaries 105 can be inserted into the samples disposed in the sample tray 120. The sample tray 120 can be moved towards the plurality of capillaries 105 such that the second end 107 of each of the plurality of capillaries 105 fluidically couples with samples disposed in the sample tray 120.

The CE system 100 can include one or more electrodes 125. The one or more electrodes 125 can be disposed in the outlet reservoir 110. The one or more electrodes 125 can be electrically coupled with the solution disposed in the outlet reservoir 110. The one or more electrodes 125 can be disposed in the inlet reservoir 115. The one or more electrodes 125 can be electrically coupled with the solution disposed in the inlet reservoir 115. The one or more electrodes 125 can electrically couple the outlet reservoir 110 to the inlet reservoir 115. The one or more electrodes 125 can be electrically coupled with the solution disposed in the outlet reservoir 110. The one or more electrodes 125 can be electrically coupled with the plurality of capillaries 105.

The CE system 100 can include one or more power supplies 130 (e.g., power source). The power supply 130 can include a source of power to an electronic circuit. The one or more electrodes 125 can electrically couple the plurality of capillaries 105 with the power supply 130. The power supply 130 can provide power to move the sample tray 120. The power supply 130 can provide power to move the inlet reservoir 115. The power supply 130 can provide power to pump a solution (e.g., gel, sieving gel) into the plurality of capillaries 105. The power supply 130 can provide power to electrokinetically inject samples into the plurality of capillaries 105.

The CE system 100 can include one or more detectors 135. The detector 135 can include a CCD (charged-coupled device) camera. The detector 135 can detect the samples from the sample tray 120. The samples can be separated according to their mass-to-charge ratio inside the plurality of capillaries 105 and be detected by the detector 135.

The CE system 100 can include one or more controllers 140. The controller 140 can be communicably connected, directly or indirectly, to the detector 135, the power supply 130, and/or other components of the CE system 100. The controller 140 can be electrically coupled with the CE system 100. The controller 140 can be an onboard computing component that is physically incorporated into housing of the CE system 100. The controller 140 can be one or more separate computing devices and/or other such controlling devices that are internal and/or external to the housing of the CE system 100. The controller 140 or a portion of the controller 140 can reside within the CE system 100. For example, the controller 140 or a portion of the controller 140 can be disposed in the CE system 100. The controller 140 can be disposed outside of the CE system 100.

The controller 140 can include one or more processors, such as but not limited to, a single-core processor, a multi-core processor, a logic device, or other such data processing circuitry, configured to execute, analyze, and process data and information of the CE system 100. The controller 140 can include a non-transitory memory device communicably connected to the processor. The memory device may be configured as a volatile memory device (e.g., SRAM and DRAM), a non-volatile memory device (e.g., flash memory, ROM, and hard disk drive), or any combination thereof. The memory device may store executable code and other such information that is generated and/or processed by the processor during operation of the CE system 100.

The CE system 100 can include one or more input/output devices communicably connected to the controller 140. The input/output device can enable an operator and/or user to receive information from the controller 140 and to input information and parameters into the controller 140. Such information and parameters can be stored in the memory device, accessed by the processor, and output to the input/output device. For example, the input/output device can include a monitor, display device, touchscreen device, keyboard, microphone, joystick, dial, button, or other such device to enable input and output of information and parameters. The input/output device may be utilized to input information into the controller 140 and output or otherwise display information and data generated by the processor of the CE system 100.

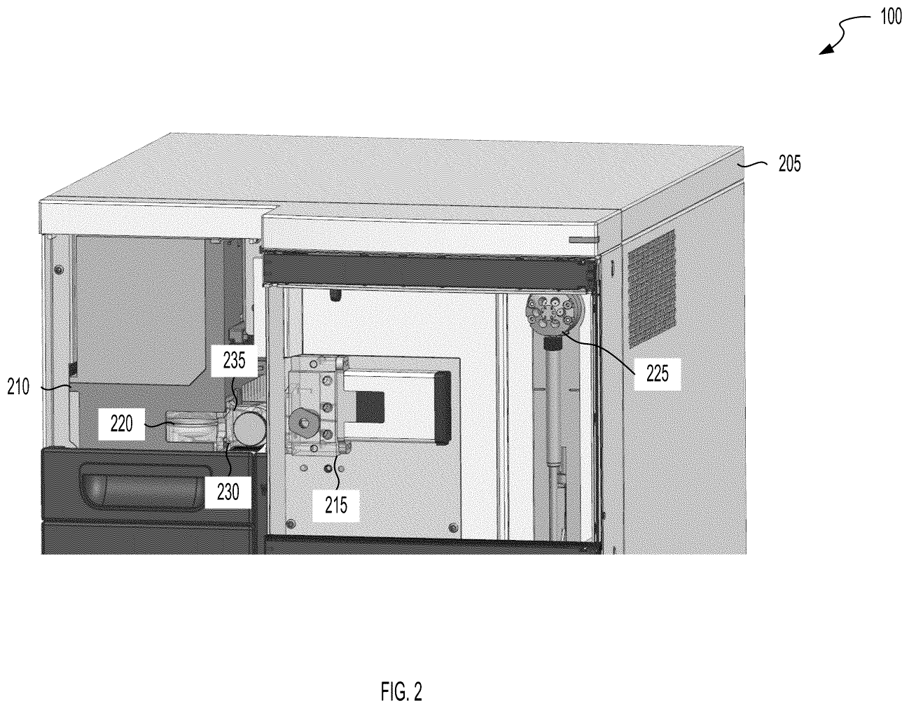

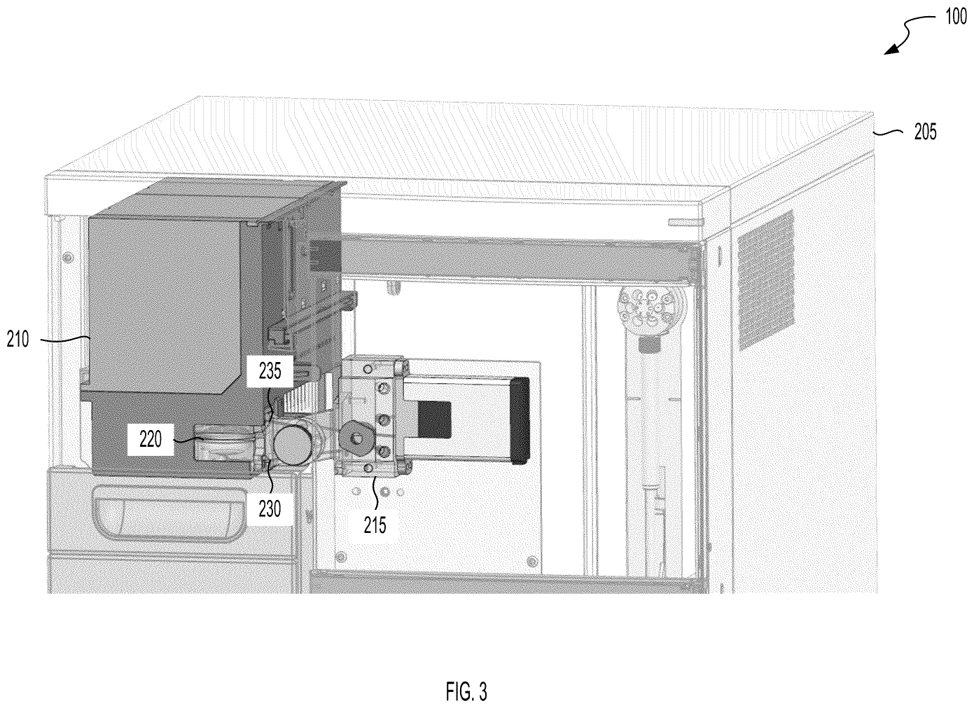

FIGS. 2 and 3 are schematic diagrams of portions of the CE system 100. The CE system 100 can include one or more housings 205. The housing 205 can contain one or more components of the CE system 100. For example, the housing 205 can contain the outlet reservoir 110, the inlet reservoir 115, the sample tray 120, the electrodes 125, the detector 135, and/or the controller 140. The outlet reservoir 110, the inlet reservoir 115, the sample tray 120, the electrodes 125, the detector 135, and/or the controller 140 can be disposed in the housing 205. The power supply 130 can be coupled with a power supply board disposed in the housing 205. The housing 205 can include one or more panels. The CE system 100 can include removable components and fixed components. Removable components of the CE system 100 can include components that are meant to be easily removed and/or replaced. Removable components of the CE system 100 can include components that are consumables. Fixed components of the CE system 100 can include components that are not meant to be easily removed and/or replaced. Fixed components of the CE system 100 can include components that are part of the CE instrument.

The CE system 100 can include one or more cartridges 210 (e.g., cartridge consumable, cartridge assembly). The cartridge 210 can be inserted into the housing 205. For example, the cartridge 210 can be inserted into the housing 205 of the CE system 100. The cartridge 210 can be removed from the housing 205. For example, the cartridge 210 can be removed from the housing 205 of the CE system 100. The cartridge 210 can be removably coupled with the housing 205. The cartridge 210 can be disposed of and/or replaced with a new cartridge. The cartridge 210 can be a consumable component of the CE system 100. The cartridge 210 can be replaced, so that there is a new reservoir, new buffer memory, and new electrode with each new consumable. Exchanging the cartridge 210 can reduce cross-contamination when two different assays or sensitive assays are run on the same CE system 100. The cartridge 210 can be a consumable that is removable from the CE instrument (e.g., main device).

The CE system 100 can include one or more manifold assemblies 215 (e.g., fluidic manifold assemblies). The manifold assembly 215 can be coupled with the housing 205. For example, the manifold assembly 215 can be fixedly (e.g., permanently) coupled with the housing 205. The manifold assembly 215 can be fixedly coupled with the housing 205 such that the manifold assembly 215 is permanently coupled with or attached to the housing 205. The manifold assembly 215 may not be removed from the housing 205 without causing structural damage. The manifold assembly 215 can be part of the CE instrument. The manifold assembly 215 can be attached to the CE instrument instead of being part of a consumable component of the CE system 100. The manifold assembly 215 can be fixed to CE instrument.

The CE system 100 can include one or more reservoir assemblies 220. The reservoir assembly 220 can be coupled with the manifold assembly 215. For example, the reservoir assembly 220 can be removably (e.g., temporarily, non-permanently) coupled with the manifold assembly 215. The reservoir assembly 220 can be removably coupled with the manifold assembly 215 such that the reservoir assembly 220 is non-permanently coupled with or attached to the manifold assembly 215. The reservoir assembly 220 can be removed from and reattached to the manifold assembly 215 without causing structural damage. The manifold assembly 215 and the reservoir assembly 220 can be coupled via at least one of a latch, a lever, a fastener, a clamp, or a screw. The reservoir assembly 220 can be a consumable component of the CE system 100. The reservoir assembly 220 may not be a part of the CE instrument. The reservoir assembly 220 can be replaced with a new reservoir assembly 220. The reservoir assembly 220 can be inserted into the cartridge 210. For example, the reservoir assembly 220 can be inserted into the cartridge 210 during manufacturing of the cartridge 210. The reservoir assembly 220 can be loosely coupled with the cartridge 210 (e.g., floating within the cartridge 210). This can allow for the relative position between the manifold assembly 215 and the reservoir assembly 220 to be tolerant to small misalignments. The reservoir assembly 220 can be replaced at the same time the cartridge 210 is replaced. For example, the reservoir assembly 220 and the cartridge 210 can belong to the same disposable and/or replaceable unit (e.g., consumable). During coupling of the reservoir assembly 220 and the manifold assembly 215, the reservoir assembly 220 can move while the manifold assembly 215 remains fixed in place.

The CE system 100 can include a pump 225 (e.g., positive displacement pump, syringe pump). The pump 225 can pump a liquid to the manifold assembly 215. The manifold assembly 215 can include ports that connect to the pump 225. The pump 225 can be fluidically coupled with the manifold assembly 215. The pump 225 can pump the liquid to the reservoir assembly 220. The pump 225 can pump the liquid into the outlet reservoir 110. The pump 225 can pump the liquid out of the outlet reservoir 110.

The CE system 100 can include a plurality of passages. The plurality of passages can be used to pump fluid into and/or out of the reservoir assembly 220. The plurality of passages can be used to vent the outlet reservoir 110. The plurality of passages can be used to fill and empty the outlet reservoir 110. The CE system 100 can include a first passage 230. The first passage 230 can include a hydraulic passage. The first passage 230 can fluidically couple the manifold assembly 215 with the reservoir assembly 220. The pump 225 can pump a fluid (e.g., liquid) into or out of the reservoir assembly 220 via the first passage 230. The first passage 230 can be disposed in the manifold assembly 215. The first passage 230 can be disposed in the reservoir assembly 220. Fluid can be pumped into or out of the outlet reservoir 110 via the first passage 230. Air can be pumped into or out of the outlet reservoir 110 via the first passage 230.

The CE system 100 can include a second passage 235. The second passage 235 can include a hydraulic passage. The second passage 235 can fluidically couple the manifold assembly 215 with the reservoir assembly 220. The pump 225 can pump fluid into or out of the reservoir assembly 220 via the second passage 235. The second passage 235 can be disposed in the manifold assembly 215. The second passage 235 can be disposed in the reservoir assembly 220. Fluid can be pumped into or out of the outlet reservoir 110 via the second passage 235. Air can be pumped into or out of the outlet reservoir 110 via the second passage 235.

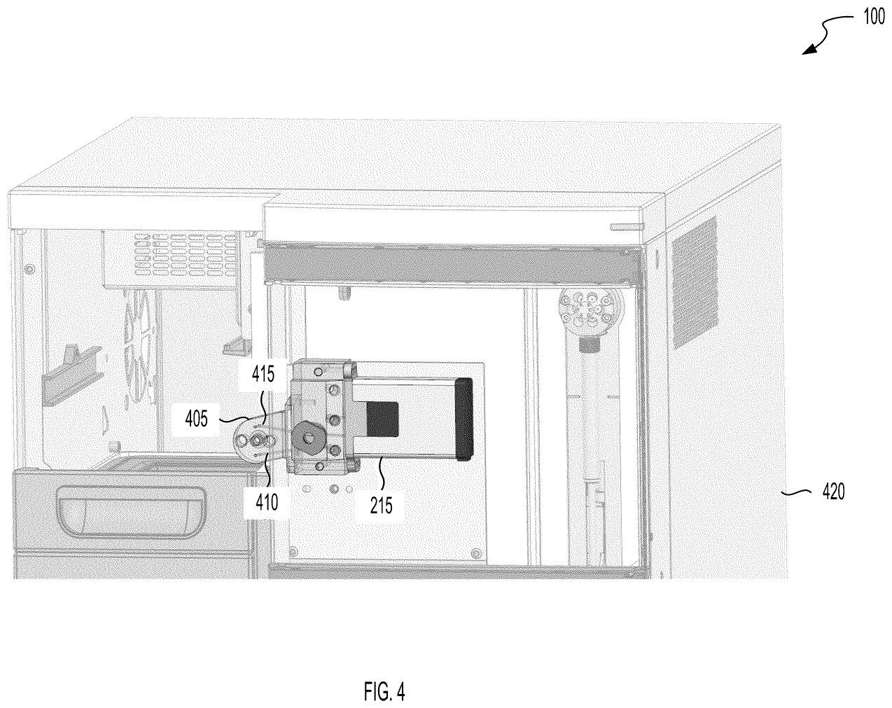

FIG. 4 is a schematic diagram of a portion of the CE system 100. The CE system 100 can include the manifold assembly 215. The manifold assembly 215 can include a manifold connector 405. The manifold connector 405 can couple with the reservoir assembly 220. The manifold connector 405 can be fixedly coupled with the manifold assembly 215. The manifold connector 405 can be removably coupled with the reservoir assembly 220.

The manifold assembly 215 can include a first passage first portion 410 (e.g., a first portion of the first passage 230). The first passage first portion 410 can be disposed in the manifold assembly 215. The first passage first portion 410 can fluidically couple the manifold assembly 215 with the reservoir assembly 220. The pump 225 can pump fluid into or out of the reservoir assembly 220 via the first passage first portion 410. The first passage first portion 410 can be fluidically coupled with the pump 225. For example, the first portion of the first passage 230 can be fluidically coupled with the positive displacement pump. The first passage first portion 410 can be disposed in the manifold connector 405.

The manifold assembly 215 can include a second passage first portion 415 (e.g., first portion of the second passage 235). The second passage first portion 415 can be disposed in the manifold assembly 215. The second passage first portion 415 can fluidically couple the manifold assembly 215 with the reservoir assembly 220. The pump 225 can pump fluid into or out of the reservoir assembly 220 via the second passage first portion 415. The second passage first portion 415 can be fluidically coupled with the pump 225. For example, the first portion of the second passage 235 can be fluidically coupled with the positive displacement pump. The second passage first portion 415 can be disposed in the manifold connector 405. The second passage first portion 415 can be separated from the first passage first portion 410 by a distance.

The CE system 100 can include the CE instrument (e.g., CE instrument 420). The CE instrument 420 can include the main device. The CE instrument 420 can include components of the CE system 100 that are not removable from the main device. The CE instrument 420 can include components of the CE system 100 that are not consumables. The CE instrument 420 can include components of the CE system 100 that do not include the cartridge 210. The CE instrument 420 can include components of the CE system 100 that do not include the reservoir assembly 220. The CE instrument 420 can be compatible with low-throughput or high-throughput systems.

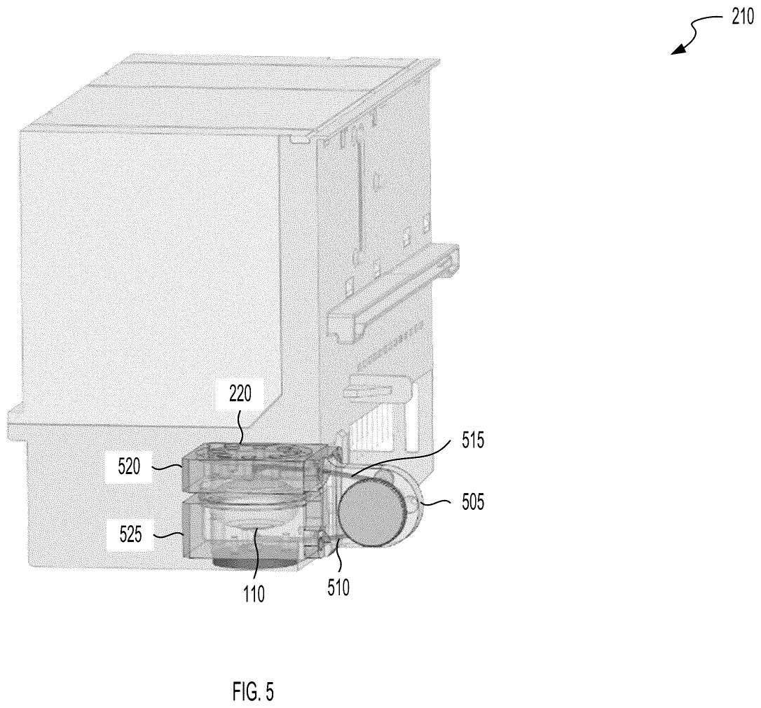

FIG. 5 is a schematic diagram of the cartridge 210. The cartridge 210 can include the reservoir assembly 220. For example, the reservoir assembly 220 can be disposed in the cartridge 210. The reservoir assembly 220 can be disposed in a portion (e.g., lower portion, upper portion, side portion) of the cartridge 210. The cartridge 210 can receive the reservoir assembly 220. For example, the cartridge 210 can include housing configured to receive the reservoir assembly 220.

The reservoir assembly 220 can include a reservoir connector 505. The reservoir connector 505 can couple with the manifold assembly 215. The reservoir connector 505 can be fixedly coupled with the reservoir assembly 220. The reservoir connector 505 can be removably coupled with the manifold assembly 215. The reservoir assembly 220 can removably couple with the manifold connector 405. The reservoir connector 505 can interface with the manifold connector 405. For example, a surface of the reservoir connector 505 can physically contact a surface of the manifold connector 405. The manifold connector 405 can form a seal with the reservoir connector 505. For example, the manifold connector 405 and the reservoir connector 505 can form a water-tight seal. The reservoir connector 505 can be removably coupled with the manifold connector 405. For example, the reservoir connector 505 and the manifold connector 405 can be removably coupled via one or more screws, levers, fasteners, clamps, or latches. The reservoir connector 505 can protrude from the cartridge 210. For example, a portion of the reservoir connector 505 can protrude from the cartridge 210. The reservoir connector 505 can align with the cartridge 210. For example, an outer surface of the reservoir connector 505 may be aligned (e.g., flush) with an outer surface of the cartridge 210. The reservoir connector 505 may not protrude from the cartridge 210.

The reservoir assembly 220 can include a first passage second portion 510 (e.g., a second portion of the first passage 230). The first passage second portion 510 can be disposed in the reservoir assembly 220. The first passage second portion 510 can fluidically couple the manifold assembly 215 with the reservoir assembly 220. The pump 225 can pump fluid into or out of the reservoir assembly 220 via the first passage second portion 510. The first passage second portion 510 can be disposed in the reservoir connector 505. The first passage second portion 510 can be fluidically coupled with the first passage first portion 410.

The reservoir assembly 220 can include a second passage second portion 515 (e.g., second portion of the second passage 235). The second passage second portion 515 can be disposed in the reservoir assembly 220. The second passage second portion 515 can fluidically couple the manifold assembly 215 with the reservoir assembly 220. The pump 225 can pump fluid into or out of the reservoir assembly 220 via the second passage second portion 515. The second passage second portion 515 can be disposed in the reservoir connector 505. The second passage second portion 515 can be separated from the first passage second portion 510 by a distance. The second passage second portion 515 can be fluidically coupled with the second passage first portion 415.

The reservoir assembly 220 can receive the plurality of capillaries 105. The plurality of capillaries 105 can be inserted into the reservoir assembly 220. For example, the plurality of capillaries 105 can be inserted into the solution disposed in the reservoir assembly 220. The first end 106 of each of the plurality of capillaries 105 can be coupled with the reservoir assembly 220.

The reservoir assembly 220 can include an upper portion 520. The upper portion 520 can include a plurality of slots. The plurality of slots can receive the plurality of capillaries 105. For example, the plurality of capillaries 105 can be inserted into the plurality of slots. The upper portion 520 can receive the plurality of capillaries 105. The second passage 235 can be disposed in the upper portion 520. For example, the second passage second portion 515 can be disposed in the upper portion 520. The upper portion 520 can be coupled with the reservoir connector 505.

The reservoir assembly 220 can include a lower portion 525. The lower portion 525 can be coupled with the upper portion 520. The lower portion 525 can receive the plurality of capillaries 105. The first passage 230 can be disposed in the lower portion 525. For example, the first passage second portion 510 can be disposed in the lower portion 525. The lower portion 525 can be coupled with the reservoir connector 505. The lower portion 525 and the upper portion 520 can be a unitary piece. The lower portion 525 and the upper portion 520 can be separate pieces.

The outlet reservoir 110 (e.g., reservoir) can be disposed in the reservoir assembly 220. For example, the outlet reservoir 110 can be formed from a first cavity of the upper portion 520 and a second cavity of the lower portion 525. The outlet reservoir 110 can receive the plurality of capillaries 105. For example, the plurality of capillaries 105 can be inserted into the outlet reservoir 110. The outlet reservoir 110 can have different volumes. The outlet reservoir 110 can have a volume in a range of 1 mL to 20 mL. The outlet reservoir 110 can be disposed in the cartridge 210. The outlet reservoir 110 can be enclosed by the cartridge 210. The volume of the outlet reservoir 110 can be driven by the required electrolyte capacity to prevent the ion depletion effect during separation (e.g., separation of analytes). The volume of the outlet reservoir 110 can be determined by the number of capillaries and required electrolyte capacity for the particular application or experiment.

The outlet reservoir 110 can be empty before insertion into to the CE instrument 420. The outlet reservoir 110 can be filled after insertion into the CE instrument 420. The outlet reservoir 110 can be filled with a plurality of liquids. For example, the outlet reservoir 110 can be filled with a first liquid. The pump 225 can pump the first liquid into the outlet reservoir 110. For example, the pump 225 can pump the first liquid though the first passage 230 into the outlet reservoir 110. The pump 225 can pump the first liquid through the second passage 235 into the outlet reservoir 110. The outlet reservoir 110 can be emptied of the first liquid. The pump 225 can pump the first liquid out of the outlet reservoir 110. For example, the pump 225 can pump the first liquid out of the outlet reservoir 110 though the first passage 230. The pump 225 can pump the first liquid out of the outlet reservoir 110 through the second passage 235.

The outlet reservoir 110 can be filled with a second liquid. The second liquid can be different from the first liquid. The second liquid can wet interior surfaces of the outlet reservoir 110. The pump 225 can pump the second liquid into the outlet reservoir 110. For example, the pump 225 can pump the second liquid though the first passage 230 into the outlet reservoir 110. The pump 225 can pump the second liquid through the second passage 235 into the outlet reservoir 110. The outlet reservoir 110 can be emptied of the second liquid. The pump 225 can pump the second liquid out of the outlet reservoir 110. For example, the pump 225 can pump the second liquid out of the outlet reservoir 110 though the first passage 230. The pump 225 can pump the second liquid out of the outlet reservoir 110 through the second passage 235.

The outlet reservoir 110 can be filled with different liquids. For example, the outlet reservoir 110 can be filled with a third liquid. The third liquid can be different from the first liquid and the second liquid. The pump 225 can pump the third liquid into the outlet reservoir 110. The pump 225 can pump the third liquid out of the outlet reservoir 110. The outlet reservoir 110 can be filled with a fourth liquid. The fourth liquid can be different from the first liquid, the second liquid, and the third liquid. The pump 225 can pump the fourth liquid into the outlet reservoir 110. The pump 225 can pump the fourth liquid out of the outlet reservoir 110. The outlet reservoir 110 can be filled with a fifth liquid. The fifth liquid can be different from the first liquid, the second liquid, the third liquid, and the fourth liquid. The pump 225 can pump the fifth liquid into the outlet reservoir 110. The pump 225 can pump the fifth liquid out of the outlet reservoir 110. The outlet reservoir 110 can be filled with and emptied of at least two different liquids. The outlet reservoir 110 can be filled with more than five different liquids. Selection of the fluid can be made by a rotary valve. The rotary valve can be disposed adjacent to the pump 225.

In a first configuration, the manifold assembly 215 can couple with the reservoir assembly 220. The reservoir assembly 220 can include the outlet reservoir 110 having a first volume. For example, the outlet reservoir 110 can have a volume of 10 mL. The outlet reservoir 110 can hold 10 mL of liquid. This outlet reservoir 110 can receive 96 capillaries. The first configuration can be used for a high-throughput CE system.

In a second configuration, the manifold assembly 215 can couple with the reservoir assembly 220. The reservoir assembly 220 can include the outlet reservoir 110 having a second volume. The second volume can be different from the first volume. For example, the outlet reservoir 110 can have a volume of 2 mL. The outlet reservoir 110 can hold 2 mL of liquid. This outlet reservoir 110 can receive 12 capillaries. The second configuration can be used for a low-throughput CE system. The outlet reservoir 110 being separated from the manifold assembly 215 can allow for the use of different reservoir volumes by exchanging the cartridge 210.

Each cartridge 210 can have a reservoir (e.g., outlet reservoir 110) with a fixed volume. For example, a first cartridge 210 can have the outlet reservoir 110 with the first volume. A second cartridge 210 can have the outlet reservoir 110 with the second volume. The second volume can be different from the first volume. This can allow the outlet reservoir 110 to be part of the consumable as opposed to the CE instrument 420. The consumable can have less than 2 years of usage. The modular fluidic system can be designed such that cartridges with different volumes can be inserted into the CE instrument 420.

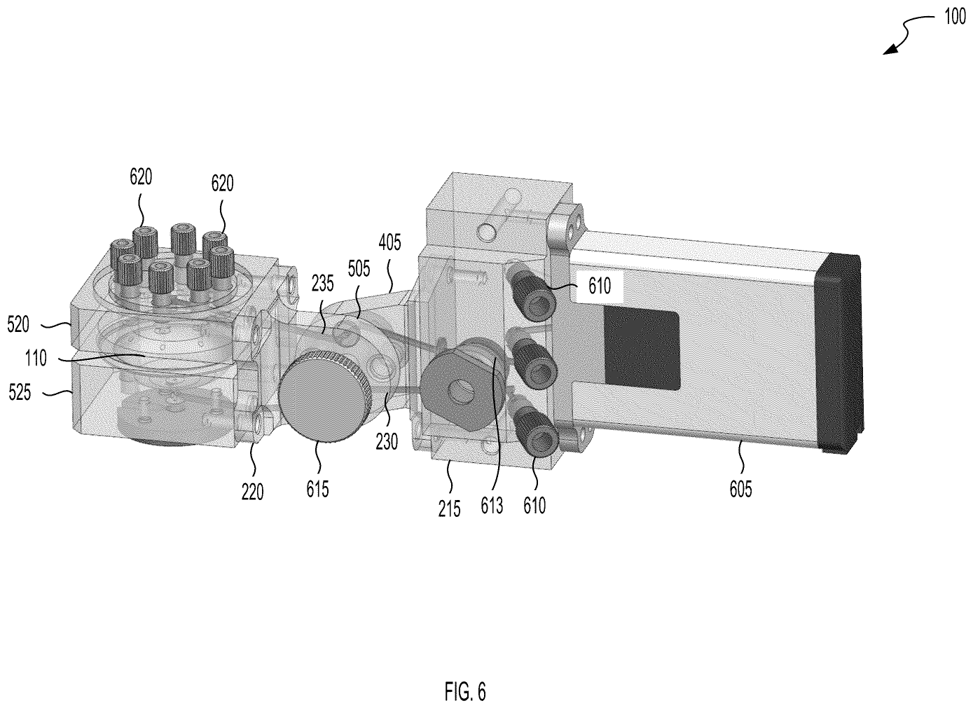

FIG. 6 is a schematic diagram of a portion of the CE system 100. The CE system 100 can include the manifold assembly 215 coupled with the reservoir assembly 220. For example, the manifold connector 405 can be coupled with the reservoir connector 505. The manifold connector 405 can be docked with the reservoir connector 505. The manifold assembly 215 can be docked with the reservoir assembly 220. The CE system 100 can include the first passage 230 and the second passage 235. The reservoir assembly 220 can include the upper portion 520 and the lower portion 525.

The manifold assembly 215 can include a valve 605 (e.g., fluidic value, pneumatic value). The valve 605 can include a 3/2-way valve. The valve 605 can have a plurality of positions. For example, the valve 605 can have a first position (e.g., ON) and a second position (e.g., OFF). The valve 605 can control flow of one or more liquids to the reservoir assembly 220. The second passage 235 can be coupled with the valve 605. The second passage 235 can be connected to the atmosphere via the valve 605. The second passage 235 can be sealed from the atmosphere via the valve 605.

The manifold assembly 215 can include a plurality of ports 610. For example, the valve 605 can include three ports. The plurality of ports 610 can fluidically couple the outlet reservoir 110 with one or more bottles (e.g., reagent bottles). For example, the plurality of ports 610 can fluidically couple the outlet reservoir 110 with the one or more bottles via the first passage 230. The plurality of ports 610 can fluidically couple the outlet reservoir 110 with the one or more bottles via the second passage 235.

The manifold assembly 215 can include a pressure sensor 613 (e.g., transducer). The pressure sensor 613 can be disposed in the manifold assembly 215. The pressure sensor 613 can sense applied pressure and output an electrical signal. The pressure sensor 613 can measure a pressure of the fluid in the first passage 230. The pressure sensor 613 can measure a pressure of the fluid in the second passage 235. The pressure sensor 613 can measure a pressure of the fluid in the first passage first portion 410. The pressure sensor 613 can measure a pressure of the fluid in the second passage first portion 415. The pressure sensor 613 can measure a pressure of the fluid in the first passage second portion 510. The pressure sensor 613 can measure a pressure of the fluid in the second passage second portion 515.

The CE system 100 can include a connecting element 615. The connecting element 615 can include a screw. The connecting element 615 can include a lever. The connecting element 615 can include a latch. The connecting element 615 can include a fastener. The connecting element 615 can include a clamp. The manifold connector 405 can be coupled with the reservoir connector 505 via the connecting element 615. The connecting element 615 can tighten a seal between the manifold connector 405 and the reservoir connector 505. The connecting element 615 can hold the manifold connector 405 and the reservoir connector 505 together. For example, the connecting element 615 can hold the manifold connector 405 and the reservoir connector 505 to keep hydraulic passages pressure-tight. The connecting element 615 can keep the first passage first portion 410 and the first passage second portion 510 pressure-tight. The connecting element 615 can keep the second passage first portion 415 and the second passage second portion 515 pressure-tight.

The reservoir assembly 220 can include a plurality of ferrules 620. The plurality of ferrules 620 can receive the plurality of capillaries 105. Each ferrule of the plurality of ferrules 620 can receive the plurality of capillaries 105. For example, each ferrule of the plurality of ferrules 620 can receive 12 capillaries. The plurality of capillaries 105 can be inserted into the plurality of ferrules 620. The outlet reservoir 110 having a 2 mL volume can have a single ferrule. The outlet reservoir 110 having a 10 mL volume can have 8 ferrules.

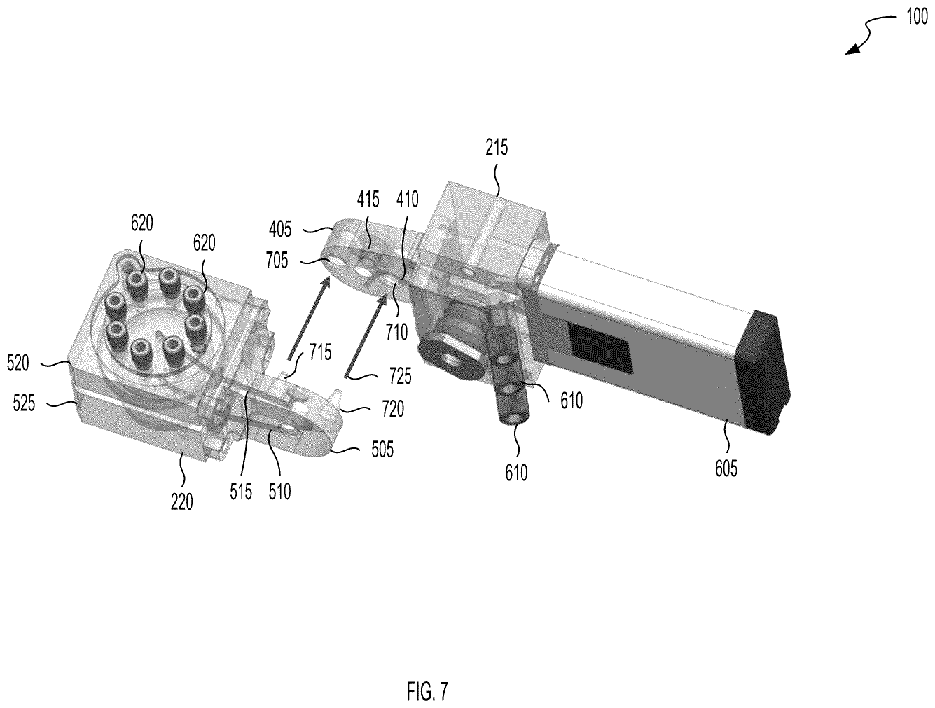

FIG. 7 is a schematic diagram of a portion of the CE system 100. The CE system 100 can include the manifold assembly 215 decoupled from the reservoir assembly 220. For example, the manifold connector 405 can be decoupled from the reservoir connector 505. The manifold connector 405 can be undocked from the reservoir connector 505. The manifold assembly 215 can be undocked from the reservoir assembly 220. The manifold assembly 215 can include the first passage first portion 410 and the second passage first portion 415. The reservoir assembly 220 can include the first passage second portion 510 and the second passage second portion 515. The reservoir assembly 220 can include the upper portion 520 and the lower portion 525. The manifold assembly 215 can include the valve 605. The manifold assembly 215 can include the plurality of ports 610. The reservoir assembly 220 can include the plurality of ferrules 620.

The manifold connector 405 can include a plurality of alignment elements (e.g., alignment features, alignment members, etc.). The plurality of alignment elements can align the manifold connector 405 with the reservoir connector 505. The plurality of alignment elements can align the manifold assembly 215 with the reservoir assembly 220. The manifold connector 405 can include one or more alignment elements. For example, the manifold connector 405 can include a first alignment element 705. The first alignment element 705 can include a first cavity. The manifold connector 405 can include a second alignment element 710. The second alignment element 710 can include a second cavity. The first alignment element 705 can be disposed a distance from the second alignment element 710. For example, the manifold connector 405 can include the first cavity disposed a first distance from the second cavity. The plurality of alignment elements can position (e.g., orient) the reservoir assembly 220 in a target position relative to the manifold assembly 215. In some embodiments, the first alignment element 705 and the second alignment element 710 can include protrusions.

The reservoir connector 505 can include a plurality of alignment elements (e.g., alignment features). The plurality of alignment elements can align the manifold connector 405 with the reservoir connector 505. The plurality of alignment elements can align the manifold assembly 215 with the reservoir assembly 220. The reservoir connector 505 can include a third alignment element 715. The third alignment element 715 can include a first protrusion. The reservoir connector 505 can include a fourth alignment element 720. The fourth alignment element 720 can include a second protrusion. The third alignment element 715 can be disposed a distance from the fourth alignment element 720. For example, the reservoir connector 505 can include the first protrusion disposed a second distance from the second protrusion. The first distance can be equal to the second distance. The distance between the first alignment element 705 and the second alignment element 710 can be the same as the distance between the third alignment element 715 and the fourth alignment element 720. The first alignment element 705 can couple with the third alignment element 715. For example, the first alignment element 705 can be inserted into the third alignment element 715. The third alignment element 715 can receive the first alignment element 705. The third alignment element 715 can be inserted into the first alignment element 705. The first alignment element 705 can receive the third alignment element 715.

The second alignment element 710 can couple with the fourth alignment element 720. The second alignment element 710 can couple with the fourth alignment element 720. For example, the second alignment element 710 can be inserted into the fourth alignment element 720. The fourth alignment element 720 can receive the second alignment element 710. The fourth alignment element 720 can be inserted into the second alignment element 710. The second alignment element 710 can receive the fourth alignment element 720.

The plurality of alignment elements can align the first passage first portion 410 with the first passage second portion 510. The plurality of alignment elements can align the second passage first portion 415 with the second passage second portion 515. The plurality of alignment elements can ensure the hydraulic passages match properly. For example, the plurality of alignment elements can ensure the first passage first portion 410 and the first passage second portion 510 are aligned with each other. The plurality of alignment elements can ensure the second passage first portion 415 and the second passage second portion 515 are aligned with each other.

The reservoir assembly 220 can couple with the manifold assembly 215 by moving the reservoir assembly 220 along a direction 725. The reservoir assembly 220 can dock with the manifold assembly 215. The reservoir connector 505 can dock with the manifold connector 405. The reservoir connector 505 can move along the direction 725 to dock the reservoir connector 505 with the manifold connector 405. The manifold connector 405 can remained fixed in place as the reservoir connector 505 is moved and docked.

The reservoir assembly 220 can include the outlet reservoir 110. The outlet reservoir 110 can be disposed in the reservoir assembly 220. The reservoir assembly 220 can removably couple with the manifold connector 405. The reservoir assembly 220 can receive the plurality of capillaries 105. The reservoir assembly 220 can include the reservoir connector 505. The reservoir connector 505 can interface with the manifold connector 405. The reservoir assembly 220 can include the second portion of the first passage 230. The second portion of the first passage 230 can be disposed in the reservoir connector 505. The second portion of the first passage 230 can be fluidically coupled with the first portion of the first passage 230. The first portion of the first passage 230 can be disposed in the manifold connector 405. The reservoir assembly 220 can include the second portion of the second passage 235. The second portion of the second passage 235 can be disposed in the reservoir connector 505. The second portion of the second passage 235 can be fluidically coupled with the first portion of the second passage 235. The first portion of the second passage 235 can be disposed in the manifold connector 405. The outlet reservoir 110 can have a first volume. The outlet reservoir 110 can have a second volume. The second volume can be different from the first volume.

The manifold assembly 215 can include the first alignment element 705 and the second alignment element 710. The first alignment element 705 can couple with the third alignment element 715 of the reservoir connector 505. The second alignment element 710 can couple with the fourth alignment element 720 of the reservoir connector 505. The reservoir assembly 220 can include the third alignment element 715 and the fourth alignment element 720. The third alignment element 715 can couple with the first alignment element 705 of the manifold connector 405. The fourth alignment element 720 can couple with the second alignment element 710 of the manifold connector 405.

In some embodiments, the outlet reservoir 110 can be filled with a first liquid. The outlet reservoir 110 can be emptied of the first liquid. The outlet reservoir 110 can be filled with a second liquid different from the first liquid. The outlet reservoir 110 can be emptied of the second liquid. The outlet reservoir 110 can be filled, emptied, and cleaned.

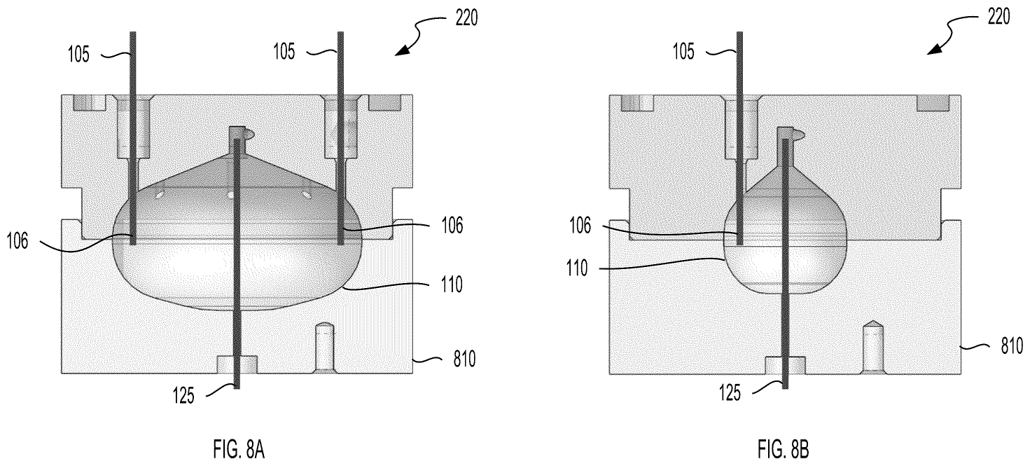

FIG. 8A is a schematic diagram of a cross-section of a portion of the reservoir assembly 220. The reservoir assembly 220 can include the electrode 125. The reservoir assembly 220 can include the plurality of capillaries 105. The plurality of capillaries 105 can be disposed in the reservoir assembly 220. Each of the plurality of capillaries 105 can include a first end (e.g., first end 106). The first end 106 of each of the plurality of capillaries 105 can be inserted into the outlet reservoir 110. The first end 106 of each of the plurality of capillaries 105 can be consolidated in the outlet reservoir 110. The outlet reservoir 110 can receive the plurality of capillaries 105. Each of the plurality of capillaries 105 can include a second end (e.g., second end 107). The second end 107 of each of the plurality of capillaries 105 can be inserted into a buffer plate. The buffer plate can include the inlet reservoir 115. The buffer plate can include the sample tray 120. In some embodiments, the electrode 125 can be disposed in the manifold assembly 215.

A first liquid can be disposed in the outlet reservoir 110. The first liquid can have a first height. A second liquid can be disposed in the buffer plate. The second liquid can have a second height. The first height can be equal to the second height. The height of the first liquid and the second liquid can be equal to prevent hydrostatic flow between the outlet reservoir 110 and the buffer plate. The height of the first liquid and the second liquid can be equal to prevent siphoning of fluid from the outlet reservoir 110 to the buffer plate or from the buffer plate to the outlet reservoir 110.

The reservoir assembly 220 can be in the first configuration. The reservoir assembly 220 can include the outlet reservoir 110 having the first volume. For example, the outlet reservoir 110 can have a volume of 10 mL. The outlet reservoir 110 can hold 10 mL of liquid. The outlet reservoir 110 can receive 96 capillaries.

The reservoir assembly 220 can include an outer profile 810. The outer profile 810 can be defined by the housing that surrounds the outlet reservoir 110. For example, the outer profile 810 can be defined by the shape of the housing that surrounds the outlet reservoir 110. The housing that surrounds the outlet reservoir 110 can couple with the cartridge 210.

FIG. 8B is a schematic diagram of a cross-section of a portion of the reservoir assembly 220. The reservoir assembly 220 can include the electrode 125. The reservoir assembly 220 can include the plurality of capillaries 105. The plurality of capillaries 105 can be disposed in the reservoir assembly 220. Each of the plurality of capillaries 105 can include a first end (e.g., first end 106). The first end 106 of each of the plurality of capillaries 105 can be inserted into the outlet reservoir 110. The outlet reservoir 110 can receive the plurality of capillaries 105. Each of the plurality of capillaries 105 can include a second end (e.g., second end 107). The second end 107 of each of the plurality of capillaries 105 can be inserted into the buffer plate. The buffer plate can include the inlet reservoir 115. The buffer plate can include the sample tray 120.

The reservoir assembly 220 can be in the second configuration. The reservoir assembly 220 can include the outlet reservoir 110 having a second volume. The second volume can be different from the first volume. For example, the outlet reservoir 110 can have a volume of 2 mL. The outlet reservoir 110 can hold 2 mL of liquid. The outlet reservoir 110 can receive 12 capillaries.

The outlet reservoir 110 shown in FIG. 8B can have a different volume than the outlet reservoir 110 shown in FIG. 8A. For example, the outlet reservoir 110 shown in FIG. 8B can have a smaller volume than the outlet reservoir 110 shown in FIG. 8A. The outlet reservoir 110 shown in FIG. 8B can have the same height as the outlet reservoir 110 shown in FIG. 8A. The outlet reservoir 110 shown in FIG. 8B can have a different width than the outlet reservoir 110 shown in FIG. 8A. For example, the outlet reservoir 110 shown in FIG. 8B can have a smaller width than the outlet reservoir 110 shown in FIG. 8A. The outlet reservoir 110 can have different shapes and sizes. The outlet reservoir 110 can have curved walls or straight walls.

The reservoir assembly 220 can include the outer profile 810. The outer profile 810 shown in FIG. 8B can be the same as the outer profile 810 shown in FIG. 8A. The outer profile 810 can be sized such that it is large enough to contain the outlet reservoir 110 shown in FIG. 8A or the outlet reservoir 110 shown in FIG. 8B.

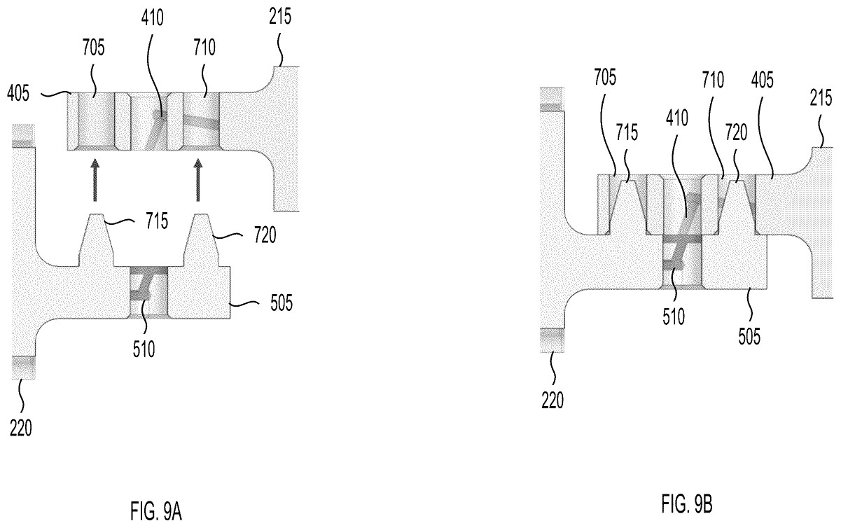

FIG. 9A is a schematic diagram of a cross-section of a portion of the reservoir assembly 220 and a portion of the manifold assembly 215. The reservoir assembly 220 and the manifold assembly 215 can be decoupled. The manifold assembly 215 can include the manifold connector 405. The manifold connector 405 can be undocked from the reservoir connector 505. The manifold assembly 215 can be undocked from the reservoir assembly 220. The manifold connector 405 can include the plurality of alignment elements. The alignment elements can compensate for rotational and translational misalignments between the reservoir assembly 220 and the manifold assembly 215 during docking. The manifold connector 405 can include the first alignment element 705. The first alignment element 705 can include the first cavity. The manifold connector 405 can include the second alignment element 710. The second alignment element 710 can include the second cavity. The first passage first portion 410 can be disposed in the manifold connector 405.

The reservoir assembly 220 can include the reservoir connector 505. The reservoir connector 505 can include the third alignment element 715. The third alignment element 715 can include the first protrusion. The third alignment element 715 can have a conical or frustoconical shape. The reservoir connector 505 can include the fourth alignment element 720. The fourth alignment element 720 can include the second protrusion. The fourth alignment element 720 can have a conical or frustoconical shape. The first passage second portion 510 can be disposed in the reservoir connector 505. The reservoir connector 505 and the manifold connector 405 can be decoupled. When the reservoir connector 505 and the manifold connector 405 are decoupled, the first passage first portion 410 and the first passage second portion 510 can be decoupled (e.g., fluidically uncoupled).

FIG. 9B is a schematic diagram of a cross-section of a portion of the reservoir assembly 220 and a portion of the manifold assembly 215. The reservoir assembly 220 and the manifold assembly 215 can be coupled. The manifold assembly 215 can include the manifold connector 405. The manifold connector 405 can be docked with the reservoir connector 505. The manifold assembly 215 can be docked with the reservoir assembly 220. The manifold connector 405 can include the plurality of alignment elements. The manifold connector 405 can include the first alignment element 705. The first alignment element 705 can include the first cavity. The manifold connector 405 can include the second alignment element 710. The second alignment element 710 can include the second cavity. The first passage first portion 410 can be disposed in the manifold connector 405.

The reservoir assembly 220 can include the reservoir connector 505. The reservoir connector 505 can include the third alignment element 715. The third alignment element 715 can include the first protrusion. The reservoir connector 505 can include the fourth alignment element 720. The fourth alignment element 720 can include the second protrusion. The first passage second portion 510 can be disposed in the reservoir connector 505. The reservoir connector 505 and the manifold connector 405 can be coupled. When the reservoir connector 505 and the manifold connector 405 are coupled, the first passage first portion 410 and the first passage second portion 510 can be coupled (e.g., fluidically coupled).

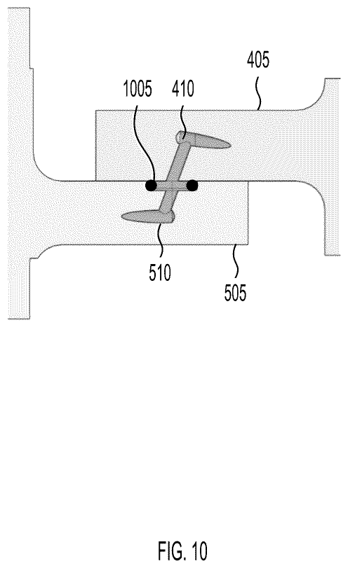

FIG. 10 is a schematic diagram of a cross-section of a portion of the reservoir assembly 220 and a portion of the manifold assembly 215. The reservoir assembly 220 and the manifold assembly 215 can be coupled. The manifold assembly 215 can include the manifold connector 405. The first passage first portion 410 can be disposed in the manifold connector 405. The reservoir assembly 220 can include the reservoir connector 505. The first passage second portion 510 can be disposed in the reservoir connector 505. The reservoir connector 505 and the manifold connector 405 can be coupled. When the reservoir connector 505 and the manifold connector 405 are coupled, the first passage first portion 410 and the first passage second portion 510 can be coupled (e.g., fluidically coupled).

The CE system 100 can include a sealing element 1005 (e.g., sealing feature, sealing member). The sealing element 1005 can include an o-ring. The sealing element 1005 can form a fluid-tight seal between the reservoir connector 505 and the manifold connector 405. For example, the sealing element 1005 can form a fluid-tight seal between the reservoir connector 505 and the manifold connector 405 when the reservoir connector 505 and the manifold connector 405 are coupled.

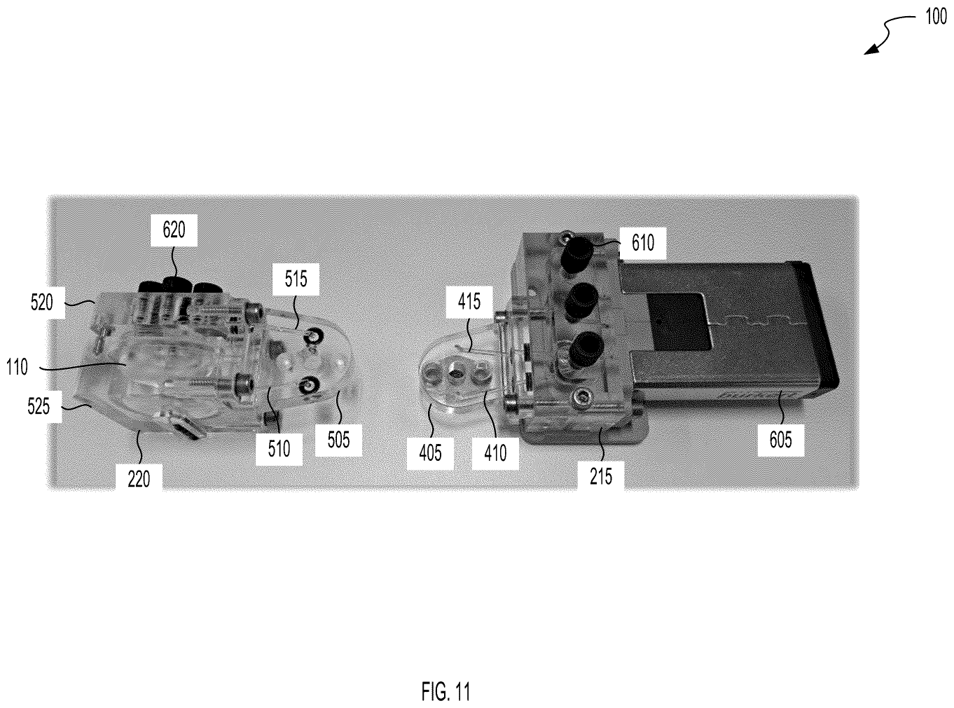

FIG. 11 is a schematic diagram of a portion of the CE system 100. The CE system 100 can include the manifold assembly 215 decoupled from the reservoir assembly 220. For example, the manifold connector 405 can be decoupled from the reservoir connector 505. The manifold assembly 215 can include the first passage first portion 410 and the second passage first portion 415. The reservoir assembly 220 can include the first passage second portion 510 and the second passage second portion 515. The reservoir assembly 220 can include the upper portion 520 and the lower portion 525. The reservoir assembly 220 can include the outlet reservoir 110. The manifold assembly 215 can include the valve 605. The manifold assembly 215 can include the plurality of ports 610. The reservoir assembly 220 can include the plurality of ferrules 620.

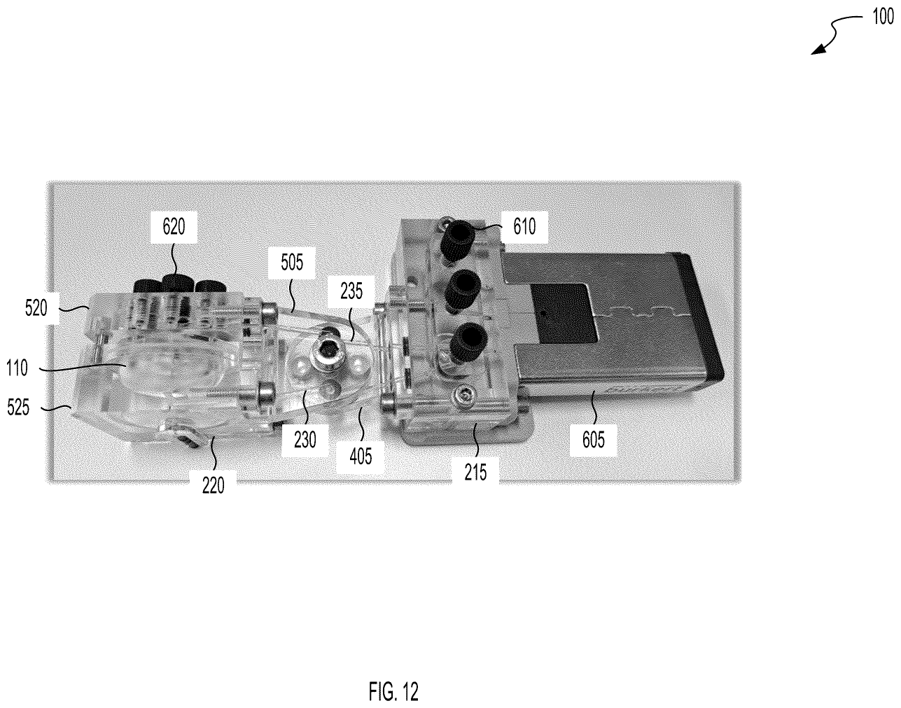

FIG. 12 is a schematic diagram of a portion of the CE system 100. The CE system 100 can include the manifold assembly 215 coupled with the reservoir assembly 220. For example, the manifold connector 405 can be coupled with the reservoir connector 505. The CE system 100 can include the first passage 230 and the second passage 235. The reservoir assembly 220 can include the upper portion 520 and the lower portion 525. The reservoir assembly 220 can include the outlet reservoir 110. The manifold assembly 215 can include the valve 605. The manifold assembly 215 can include the plurality of ports 610. The reservoir assembly 220 can include the plurality of ferrules 620.

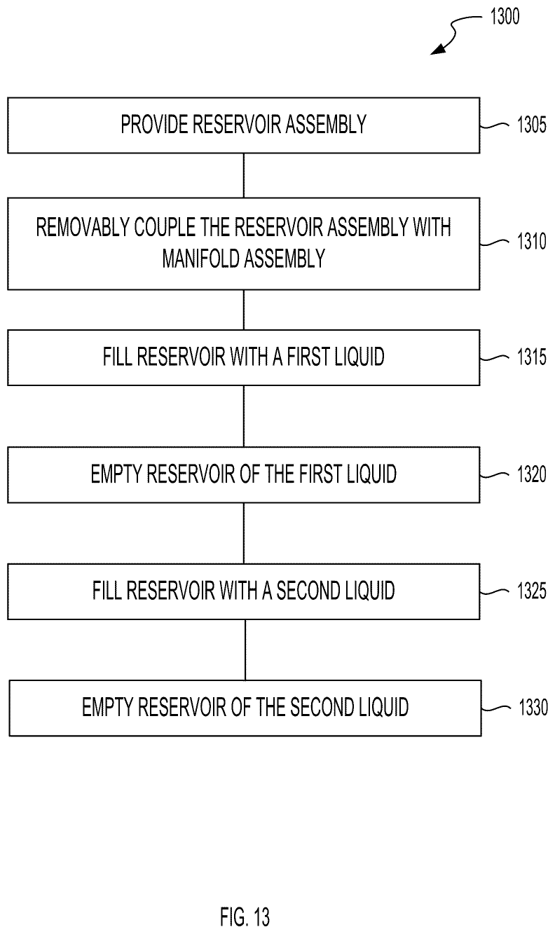

FIG. 13 is a schematic flow diagram illustrating a method 1300 for providing and/or using a reservoir assembly. The method 1300 can include providing a reservoir assembly (operation 1305). The method 1300 can include removably coupling the reservoir assembly with a manifold assembly (operation 1310). The method 1300 can include filing a reservoir with a first liquid (operation 1315). The method 1300 can include emptying the reservoir of the first liquid (operation 1320). The method 1300 can include filing the reservoir with a second liquid (operation 1325). The method 1300 can include emptying the reservoir of the second liquid (operation 1330).

The method 1300 can include providing a reservoir assembly (operation 1305). The reservoir assembly can include a reservoir (e.g., outlet reservoir) disposed in the reservoir assembly. The reservoir assembly can removably couple with a manifold connector. The reservoir assembly can receive a plurality of capillaries. The reservoir assembly can include a reservoir connector. The reservoir connector can interface with the manifold connector. The reservoir assembly can include a second portion of a first passage disposed in the reservoir connector. The second portion of the first passage can be fluidically coupled with a first portion of the first passage disposed in the manifold connector. The reservoir assembly can include a second portion of a second passage disposed in the reservoir connector. The second portion of the second passage can be fluidically coupled with a first portion of the second passage disposed in the manifold connector. The reservoir can have a first volume or a second volume different from the first volume.

The method 1300 can include removably coupling the reservoir assembly with a manifold assembly (operation 1310). The manifold assembly and the reservoir assembly can be coupled via at least one of a latch, a lever, screw, or clamp. The manifold assembly can include a manifold connector. The manifold connector can be removably coupled with the reservoir assembly. The reservoir connector can be removably coupled with the manifold assembly. The reservoir connector can be removably coupled with the manifold connector.

The method 1300 can include filing a reservoir with a first liquid (operation 1315). The pump can pump the first liquid into the reservoir. The pump can pump the first liquid through the first passage into the reservoir. The pump can pump the first liquid through the second passage into the reservoir.

The method 1300 can include emptying the reservoir of the first liquid (operation 1320). The pump can pump the first liquid out of the reservoir. The pump can pump the first liquid out of the reservoir through the first passage. The pump can pump the first liquid out of the reservoir through the second passage.

The method 1300 can include filing the reservoir with a second liquid (operation 1325). The pump can pump the second liquid into the reservoir. The pump can pump the second liquid through the first passage into the reservoir. The pump can pump the second liquid through the second passage into the reservoir. The second liquid can be different from the first liquid.

The method 1300 can include emptying the reservoir of the second liquid (operation 1330). The pump can pump the second liquid out of the reservoir. The pump can pump the second liquid out of the reservoir through the first passage. The pump can pump the second liquid out of the reservoir through the second passage.

In some embodiments, the reservoir is configured to be filled with a first liquid. The reservoir can be configured to be emptied of the first liquid. The reservoir can be configured to be filled with a second liquid different from the first liquid. In some embodiments, the reservoir assembly is configured to aligned with the manifold connector.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

While operations can be depicted in the drawings in a particular order, such operations are not required to be performed in the particular order shown or in sequential order, and all illustrated operations are not required to be performed. Actions described herein can be performed in a different order.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A capillary electrophoresis system, comprising:
a housing;
a manifold assembly fixedly coupled with the housing, the manifold assembly comprising:
a manifold connector comprising:
a first portion of a first passage; and
a first portion of a second passage; and
a reservoir assembly removably coupled with the manifold assembly, the reservoir assembly configured to receive a plurality of capillaries and comprising:
a reservoir disposed in the reservoir assembly;
a reservoir connector configured to interface with the manifold connector, the reservoir connector comprising:
a second portion of the first passage, the second portion of the first passage configured to be fluidically coupled with the first portion of the first passage; and
a second portion of the second passage, the second portion of the second passage configured to be fluidically coupled with the first portion of the second passage,
wherein, in a first configuration, the manifold assembly is configured to couple with the reservoir assembly comprising the reservoir having a first volume, and
wherein, in a second configuration, the manifold assembly is configured to couple with the reservoir assembly comprising the reservoir having a second volume different from the first volume.

2. The capillary electrophoresis system of claim 1, further comprising:
a cartridge configured to be inserted into the housing,
wherein the reservoir is configured to be disposed in the cartridge.

3. The capillary electrophoresis system of claim 2, wherein the reservoir connector is configured to protrude from the cartridge or align with the cartridge.

4. The capillary electrophoresis system of claim 1, wherein:
the reservoir is configured to be filled with a first liquid,
the reservoir is configured to be emptied of the first liquid,
the reservoir is configured to be filled with a second liquid different from the first liquid, and
the reservoir is configured to be emptied of the second liquid.

5. The capillary electrophoresis system of claim 1, wherein the manifold connector comprises a plurality of alignment elements.

6. The capillary electrophoresis system of claim 1, wherein:
the manifold connector comprises a first alignment element and a second alignment element,
the reservoir connector comprises a third alignment element and a fourth alignment element,
the first alignment element configured to couple with the third alignment element, and
the second alignment element configured to couple with the fourth alignment element.

7. The capillary electrophoresis system of claim 1, wherein:
the manifold connector comprises a first cavity disposed a first distance from a second cavity,
the reservoir connector comprises a first protrusion disposed a second distance from a second protrusion, and
the first distance is equal to the second distance.

8. The capillary electrophoresis system of claim 1, wherein the manifold connector is configured to form a seal with the reservoir connector.

9. The capillary electrophoresis system of claim 1, further comprising:
a positive displacement pump,
wherein the first portion of the first passage is fluidically coupled with the positive displacement pump.

10. The capillary electrophoresis system of claim 1, further comprising:
a positive displacement pump configured to pump a liquid into or out of the reservoir.

11. The capillary electrophoresis system of claim 1, further comprising:
a pressure sensor disposed in the manifold assembly.

12. The capillary electrophoresis system of claim 1, further comprising:
the plurality of capillaries, each of the plurality of capillaries comprising a first end,
wherein the first end of each of the plurality of capillaries configured to be inserted into the reservoir.

13. The capillary electrophoresis system of claim 1, further comprising:
an electrode disposed in the reservoir.

14. The capillary electrophoresis system of claim 1, wherein the manifold assembly and the reservoir assembly are configured to be coupled via at least one of a latch, a lever, screw, or clamp.

15. A reservoir assembly, comprising:
a reservoir disposed in the reservoir assembly, the reservoir assembly configured to removably couple with a manifold connector and configured to receive a plurality of capillaries;
a reservoir connector configured to interface with the manifold connector;
a second portion of a first passage disposed in the reservoir connector, the second portion of the first passage configured to be fluidically coupled with a first portion of the first passage disposed in the manifold connector; and
a second portion of a second passage disposed in the reservoir connector, the second portion of the second passage configured to be fluidically coupled with a first portion of the second passage disposed in the manifold connector,
wherein the reservoir has a first volume or a second volume different from the first volume.

16. The reservoir assembly of claim 15, further comprising a plurality of alignment elements.

17. The reservoir assembly of claim 15, wherein:
the reservoir is configured to be filled with a first liquid,
the reservoir is configured to be emptied of the first liquid,
the reservoir is configured to be filled with a second liquid different from the first liquid, and
the reservoir is configured to be emptied of the second liquid.

18. A method, comprising:
providing a reservoir assembly, the reservoir assembly comprising:
a reservoir disposed in the reservoir assembly, the reservoir assembly configured to removably couple with a manifold connector and configured to receive a plurality of capillaries;
a reservoir connector configured to interface with the manifold connector;
a second portion of a first passage disposed in the reservoir connector, the second portion of the first passage configured to be fluidically coupled with a first portion of the first passage disposed in the manifold connector; and
a second portion of a second passage disposed in the reservoir connector, the second portion of the second passage configured to be fluidically coupled with a first portion of the second passage disposed in the manifold connector,
wherein the reservoir has a first volume or a second volume different from the first volume.

19. The method of claim 18, wherein:
the reservoir is configured to be filled with a first liquid,
the reservoir is configured to be emptied of the first liquid,
the reservoir is configured to be filled with a second liquid different from the first liquid,
the reservoir is configured to be emptied of the second liquid.

20. The method of claim 19, wherein the reservoir assembly is configured to be aligned with the manifold connector.
